(19) United States
(12) Patent Application Publication
(10) Pub. No.: US 2013/0102341 A1
(43) Pub. Date: Apr. 25, 2013

(54) COGNITIVE TRANSMISSION CONTROL SYSTEM

(71) Applicant: XG TECHNOLOGY, INC., Sarasota, FL (US)

(72) Inventors: PERTTI ALAPURANEN, DELTONA, FL (US); JINU KURIAN, SUNRISE, FL (US); BRAD RAINBOLT, SUNRISE, FL (US); SREEKANT NAIR, PLANTATION, FL (US)

(73) Assignee: XG TECHNOLOGY, INC., Sarasota, FL (US)

(21) Appl. No.: 13/654,458

(22) Filed: Oct. 18, 2012

Related U.S. Application Data
(60) Provisional application No. 61/549,837, filed on Oct. 21, 2011.

(51) Int. Cl. H04B 15/00; H04W 24/02

(52) U.S. Cl. 455/501

(57) ABSTRACT

A cognitive radio transmission control system that controls the physical layer protocol based on algorithm feedback from receivers is disclosed.

### CROSS-REFERENCE TO RELATED APPLICATION

The present application claims the benefit of previously filed co-pending Provisional Patent Application, Ser. No. 61/549,837 filed Oct. 21, 2011.

### FIELD OF THE INVENTION

This invention describes a cognitive radio transmission control system, and more specifically is a cognitive system that controls the physical layer protocol based on algorithm feedback from receivers.

### BACKGROUND OF THE INVENTION

Cognitive (“smart”) radio technology allows dynamic spectrum sensing, spectrum management, mobility, and spectrum sharing, to mention a few. Classical cognitive radios change frequency channels when interference levels, or other parameters associated with operation, can be improved by moving to a different frequency. This traditional cognitive concept can be expanded by adding interference mitigation that allows more robust communication capabilities for military and commercial operations in frequencies that are unlicensed or have uncoordinated transmissions from other systems.

In the expanded cognitive radio concept of this disclosure receiver decoder algorithms and transmit waveforms are dynamically adjusted for the operational environment of terminals and base stations. The Physical Layer (PHY) and Medium Access Layer (MAC) dynamically adjust operation, including protocol, to mitigate interference.

Radio spectrum is a limited resource. A large amount of spectrum is required to deliver services that are associated with modern wireless personal communications. Typical examples are smart phone Internet applications, wireless streaming audio, and video, to mention a few. These services consume large amounts of spectral resources causing both financial and spectrum policy issues.

Typically these services are provided using licensed spectrum. The financial burden from licensing is billions of dollars, even for a relatively small amount of spectrum, when compared to freely available unlicensed spectrum. The licensing, however, is required to make sure that current 1G to 4G radio technologies have the coordinated access they require to deliver quality of service that is adequate for an end user application.

Currently in United States there are several hundred MHz of unlicensed spectrum that can be used for delivering wireless services to consumers, however, traditional radio technologies typically suffer from interference from uncoordinated access by other unlicensed users. A novel radio technology is required that can deliver service while being highly resistant to interference and while also creating as little interference as possible to other users in the unlicensed band.

### BRIEF SUMMARY OF THE INVENTION

The invention of this disclosure consists of a cognitive transmission control system that uses control messages that are sent by a Mobile Station (MS) to a Base Station (BS), and vice versa. Typically these types of control messages are used for power, timing, or for controlling modulation and coding rates. In this invention the physical layer protocol is controlled based on decoder algorithm feedback from receivers.

### DETAILED DESCRIPTION OF THE INVENTION

Adjusting modulation and coding rates is challenging when burst interference is present. Traditional designs often do not take into account the fact that when interference is present, decreasing the modulation or coding rate in response to a decrease in performance can actually hurt performance even more. The reason for this unexpected consequence is that decreasing the modulation or coding rate typically increases the packet length, thus making it even more vulnerable to burst interference. By contrast, in traditional AWGN channel scenarios, the same decrease in modulation or coding rate typically improves performance. For this reason this invention describes a new type of system that adds information about the decoding algorithm that was used to decode the packet.

In the preferred embodiment the receiver uses subspace projection along with redundant coding and combining. These decoder algorithms are layered so that the cognitive receiver can use different combinations.

For example, if subspace projection produced error free data at the receiver then a conclusion can be made that modulation methods that can use the projection based methods should be used when transmitting data to the receiver. Additionally, if redundancy was required to receive data, then the system should use that method for all data that is sent to a particular destination. The receiver decoder algorithm that succeeded (i.e. produced an error free packet) indirectly informs the receiver on what type of interference was mitigated. This information is important because lowering the modulation and coding rate in the presence of interference can make data bursts longer, thus making them more vulnerable to interference bursts. If the receiver has information on the type of interference then it can select proper transmission protocols and parameters to maximize system capacity.

When compared to traditional feedback systems the described system is nonlinear, i.e. the parameters adjusted may change direction while reacting to linearly increasing measure. For example, in bursty conditions the system may increase the coding and modulation rate when the frame error rate increases while a traditional linear system would do the opposite.

When a mobile station (MS) receives its downlink packet traffic it independently makes a decision on the most appropriate modulation and coding scheme (MCS) to be used for its channel conditions and passes that information to the base station (BS). Downlink CQI as measured by the mobile station is a 3-tuple and reports are sent to the BS including:

1) SINR: Reported on a per frame basis. The SINR reported should be independent of any interference present on the channel and linear over the entire range.

2) Decoder algorithm: If decoded correctly, the decoder algorithm used by the receiver block should be reported. There are 4 possible values in the preferred embodiment system:
a. MRC (Maximal Ratio Combining).
b. Subspace projection (LMS, uses 4 antenna MIMO receiver, maximizes SNR).
c. Both.
d. Redundant mode (same data is sent twice or more times separated by a small time delta).

3) Interference indicator: If the received frame had an interferer present, this should also be indicated (this is a list of time moments where interference was detected).

If mobile stations are reporting errors, i.e. deteriorating downlink performance, the Base Station (BS) can use the information provided to trigger a channel change. The channel metric is computed as a function of the mobile reported channel quality added to the base station measured information. The BS measured information indicates uplink performance while the mobile station measured information indicates downlink performance.

The Signal to Interference plus Noise (SINR) is calculated as SINR=P/(I+N) where P is signal power, I is interference power and N is noise power. SINR is reported to the BS on a per frame basis. The decoder algorithm contains information regarding the decoder used in the receiver. There are 4 possible values in the system: MRC (Maximal Ratio Combining), subspace projection (LMS Beam forming, uses 4 antenna MIMO receiver) where both modes have an additional redundant mode (same data is sent twice or more times separated by a small time delta).

The interference indicator is a list of time moments where interference was detected. The format is a bitmap of slots of predetermined duration that contains interference in a super frame. If interference is consistently reported in a slot then the BS transmitter selects a coding rate that allows reliable communication. Additionally the BS scheduler can schedule transmissions to mobile stations to avoid local interference that is synchronous to the TDD framing.

When the BS receives message traffic it will independently make a decision on the most appropriate modulation and coding (MCS) scheme to be used for its channel conditions and then pass that information to the MS. This decision is based on the measured uplink Channel Quality Information (CQI) measured at the base station. Uplink CQI as measured is a 3-tuple:

1) SINR: signal over interference+noise is reported on a per user basis, this is the same for all end devices bridged to the same terminal.

2) Decoder algorithm: If decoded correctly, the decoder algorithm used by the receiver block should be reported. There are 4 possible values in the current system:
a. MRC (Maximal Ratio Combining).
b. Subspace projection (LMS Beam forming, uses 4 antenna MIMO receiver).
c. Both.
d. Redundant mode (same data is sent twice or more times separated by a small time delta).

3) Interference indicator: If the received frame had an interferer present, this should also be indicated (this is a list of time moments where interference was detected).

Based on the CQI, the Base Station selects the uplink MCS (Modulation and Coding) recommendation in two stages as described in the algorithm below:

1) MCS range selection: This selection is based on the specific decoder algorithm used. If MRC was used, then all MCS are available for selection. If the redundant mode was used, the MCS range selection is restricted to transmission protocols where same data is sent at least twice, back to back, separated by a small time delta.

2) Choose candidate MCS: An MCS is chosen from the range as selected in step 1 that will maximize the data rate given a specific SINR value.

3) Interference measurement: In this step the presence of interferers is accounted for.

If an interferer was reported in the packet the MS will update an interference map for the uplink slots. Note: A slot is a logical concept and does not refer to an actual TDMA slot.

Since certain changes may be made in the above described system and method for a cognitive transmission control system without departing from the scope of the invention herein involved, it is intended that all matter contained in the description thereof shall be interpreted as illustrative and not in a limiting sense.

What is claimed is:

1) A cognitive transmission control method to switch between transmission channels, modulation methods, and coding schemes using control messages between a mobile station and a base station that are both using multiple receiver decoder algorithms to decode received downlink and uplink transmissions comprising:
said mobile station measuring downlink channel quality information based on signal to noise ratio, which mobile station decoder algorithm of said multiple receiver decoder algorithms properly decoded the downlink transmission, and list of time moments where interference was detected, and then reporting said measured downlink channel quality information to said base station;
said base station measuring uplink channel quality information based on signal to noise ratio, which base station decoder algorithm of said multiple receiver decoder algorithms properly decoded the uplink transmission, and list of time moments where interference was detected, and then making measurement decisions based on the information; and,
said base station then using said reported measured downlink channel quality information and said measurement decisions regarding uplink channel quality information to determine a transmission channel, modulation method, and coding scheme to use for base station and mobile station transmissions.
